(19) United States
(12) Patent Application Publication
(10) Pub. No.: US 2010/0171816 A1
(43) Pub. Date: Jul. 8, 2010

(54) DISPLAY DEVICE FOR THREE DIMENSIONAL (3D) IMAGES

(75) Inventor: Chueh-Pin Ko, Taipei Hsien (TW)

Correspondence Address: SNELL & WILMER L.L.P. (Main), 400 EAST VAN BUREN, ONE ARIZONA CENTER, PHOENIX, AZ, 85004-2202, US

(73) Assignee: ACER INCORPORATED, Taipei Hsien (TW)

(21) Appl. No.: 12/635,931

(22) Filed: Dec. 11, 2009

(30) Foreign Application Priority Data
Jan. 8, 2009 (TW) 98100462

(51) Int. Cl. H04N 15/00

(52) U.S. Cl. 348/51; 348/E15.001

(57) ABSTRACT

The present invention provides a display device for three-dimensional (3D) images. The display device presents a first and a second frame respectively to left and right eyes of a user, whereby the user perceives a 3D image according to the first and second frames. The display device includes a digital signal processor and an image output module. The digital signal processor generates the first and second frames according to 3D image signals, and the image output module outputs the first and second frames sequentially. The first frame has a first color wavelength distribution, and the second frame has a second color wavelength distribution. The first color wavelength distribution is different from the second color wavelength distribution. At least one of the first color wavelength distribution and the second color wavelength distribution corresponds to at least two colors selected from a color group consisting of red, green, and blue.

### CROSS REFERENCE TO RELATED APPLICATIONS

This application claims the right of priority based on Taiwan Patent Application No. 98100462 entitled “A DISPLAY FOR THREE DIMENSIONAL (3D) IMAGES,” filed on Jan. 8, 2009, which is incorporated herein by reference and assigned to the assignee herein.

### FIELD OF THE INVENTION

This invention relates to a display device for three-dimensional (3D) images, and more particularly to a display device capable of presenting frames of different color wavelength distributions, wherein users perceive a 3D image according to these frames.

### BACKGROUND OF THE INVENTION

The conventional 3D image display technologies are mainly divided into two categories depending on whether polarizer glasses are used or not. One of them needs polarizer glasses, such as red-blue glasses, or mask glasses. The other does not need polarizer glasses, but utilizes light grids or lenses to generate the 3D image at different angles.

The 3D image is perceived in a user's brain when two different images are respectively received from left and right eyes. In the conventional 3D image display technologies, a full-color 3D image is not obtainable because the two different images from the left and right eyes respectively carry single color only. For example, the user cannot perceive the full-color 3D image because he, with a pair of red-blue glasses, receives simply a red image and a blue image respectively through the left and right eyes. In addition, the complexity and the costs of the conventional display device will increase when it is used for generation of 3D images.

Accordingly, a display device for full-color 3D images is desirable.

### SUMMARY OF THE INVENTION

One aspect of the present invention is to provide a display device for three-dimensional (3D) images. The display device respectively presents a first and a second frames to left and right eyes of a user, whereby the user perceives a 3D image according to the first and second frames.

Another aspect of the present invention is to provide a display device for three-dimensional (3D) images. The display device presents a frame to a first filter corresponding to the left eye of a user and to a second filter corresponding to the right eye of the user. The first filter allows light of a first color wavelength distribution to pass, and the second filter allows light of a second color wavelength distribution to pass. The frame is filtered respectively by the first and second filters, whereby the user perceives a 3D image.

Still another aspect of the present invention is to provide a method for generating three-dimensional (3D) images. The method includes the step of generating an output frame according to 3D image signals. The output frame includes first and/or second frames superimposed thereon. The first frame has a first color wavelength distribution, and the second frame has a second color wavelength distribution. A user utilizes a filter to perceive the 3D image.

One embodiment of the invention discloses a display device for three-dimensional (3D) images. The display device respectively presents a first and a second frames to left and right eyes of a user, whereby the user perceives a 3D image according to the first and second frames. The display device includes a digital signal processor and an image output module. The digital signal processor generates the first and second frames according to 3D image signals, and the image output module outputs the first and second frames sequentially. The first frame has a first color wavelength distribution, and the second frame has a second color wavelength distribution. The first color wavelength distribution is different from the second color wavelength distribution, or the first color wavelength distribution and the second color wavelength distribution do not overlap completely. At least one of the first color wavelength distribution and the second color wavelength distribution corresponds to at least two colors selected from a color group consisting of red, green, and blue.

Another embodiment of the invention discloses a display device for three-dimensional (3D) images. The display device presents a frame to a first filter corresponding to the left eye of a user and to a second filter corresponding to the right eye of the user. The first filter allows light of a first color wavelength distribution pass, and the second filter allows light of a second color wavelength distribution pass. The frame is filtered respectively by the first and second filters. The display device includes a digital signal processor and an image output module. The digital signal processor generates the frame according to 3D image signals, and the frame further includes first and second frames superimposed thereon. The image output module outputs the frame. The first frame has the first color wavelength distribution, and the second frame has the second color wavelength distribution. The first color wavelength distribution is different from the second color wavelength distribution. At least one of the first color wavelength distribution and the second color wavelength distribution corresponds to at least two colors selected from a color group consisting of red, green, and blue, whereby the user perceives the 3D image according to the first and second frames.

Another embodiment of the invention discloses a method for generating three-dimensional (3D) images. The method includes the step of generating an output frame according to 3D image signals, and the output frame includes first and second frames superimposed thereon. The method also includes the step of subsequently or simultaneously isolating the first frame and a first color wavelength distribution corresponding thereto and isolating the second frame and a second color wavelength distribution corresponding thereto. The method further includes the step of subsequently or simultaneously receiving the first frame and the second frame via the first and second filters.

By way of the abovementioned aspects, the present invention provides a light emitting diode and methods of forming the same. The objects and the features of the present invention may best be understood by reference to the detailed description.

### BRIEF DESCRIPTION OF THE DRAWINGS

FIG. 1 is a block diagram illustrating one embodiment of a display device for three-dimensional (3D) images in accordance with the present invention.

FIG. 2a depicts the display device shown in FIG. 1.

FIG. 2b illustrates one embodiment of a 3D image projector in accordance with the present invention.

FIG. 3a depicts the display device shown in FIG. 1.

FIG. 3b is a scheme illustrating one embodiment of a 3D image projector in accordance with the present invention.

FIG. 4 is a flowchart illustrating one embodiment of a method for generating three-dimensional (3D) images in accordance with the present invention.

### DETAILED DESCRIPTION OF THE INVENTION

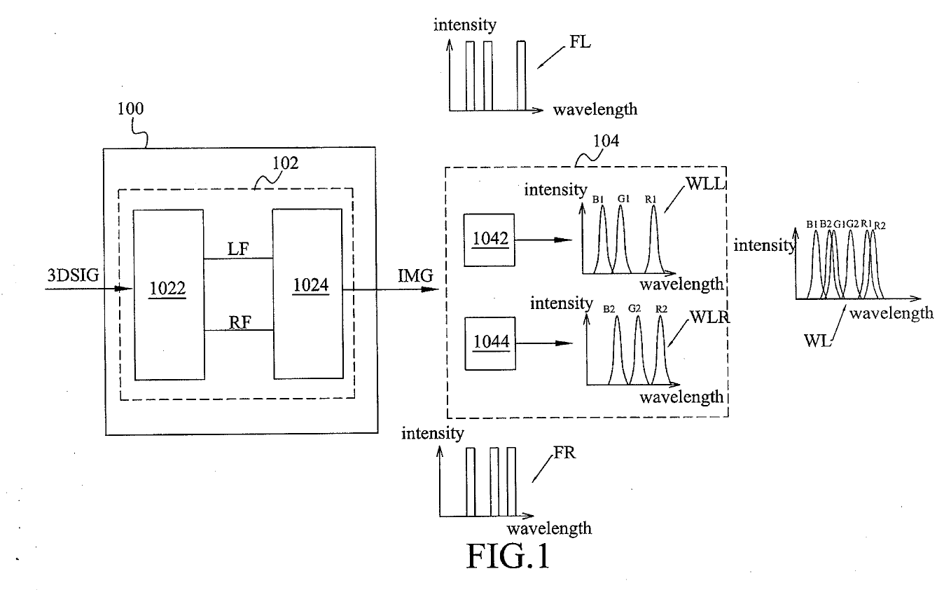

In the following embodiments, a display device for three-dimensional (3D) images is disclosed. The display device is capable of presenting frames of different color wavelength distributions, wherein users perceive a 3D image according to these frames. The preferred embodiments of the present invention will now be described in greater details by referring to FIG. 1 to FIG. 4 that accompany the present application.

FIG. 1 is a block diagram illustrating one embodiment of a display device 100 for three-dimensional (3D) images in accordance with the present invention. The display device 100 includes a display unit 102. The display unit 102 generates and presents an output frame IMG according to 3D image signals 3DSIG. In addition, the display unit 102 is coupled to an image receiving unit 104, such that the user can perceive the output frame IMG. The display unit 102 further includes a digital signal processor 1022 and an image output module 1024. The digital signal processor 1022 generates a left frame LF and a right frame RF according to the 3D image signals 3DSIG. The image output module 1024 outputs the output frame IMG including the left frame LF and/or the right frame RF. The image receiving unit 104 further includes a left receiving unit 1042 for the left eye and a right receiving unit 1044 for the right eye. The image receiving unit 104, for example, can be a pair of glasses, and the left receiving unit 1042 and the right receiving unit 1044 are lenses.

The left receiving unit 1042 and the right receiving unit 1044 include specific films or filters having a polarizing element, such that the user perceives the left frame LF or the right frame RF of the output frame IMG from the display unit 102 respectively through the left receiving unit 1042 or the right receiving unit 1044. Preferably, the left receiving unit 1042 and the right receiving unit 1044 respectively receives the left frame LF or the right frame RF having a color wavelength distribution different from that of the left frame LF. Generally, the color can be represented as wavelength distribution. The left receiving unit 1042 and the right receiving unit 1044 can be filters for allowing light of specific wavelengths pass. The left or right eye of the user receives the left frame LF or the right frame RF of different wavelengths and strengths through the left receiving unit 1042 and the right receiving unit 1044, such that the 3D image is perceived in the user's brain. In another embodiment, colors can be represented as RGB histograms, and each histogram has 256 levels ranging from 0 to 255.

In one embodiment, the digital signal processor 1022 processes 3D image signals 3DSIG to generate and isolate signals for the left frame LF and/or the right frame RF.

In another embodiment, signals for the left frame LF and the right frame RF have been previously pre-defined or separated in the 3D image signals 3DSIG. In doing so, the left frame LF and the right frame RF can be easily isolated without extra calculations.

The left frame LF and the right frame RF generated in the above-mentioned embodiments provide respective color wavelength distributions to an image output module 1024. The image output module 1024, for example, can be an LCD device with a back light, a DLP projector, a 3LCD projector, an RGB-LED device, or self-emission devices, e.g. an OLED device or a PDP device. Generally, the image output module 1024 includes an optical unit and a display unit. In one embodiment, the image output module 1024 is an LCD device; the optical unit is a backlight module; and the display unit is an array substrate with liquid crystal thereon. In another embodiment, the image output module 1024 is a DLP projector; the optical unit is a high pressure lamp or a color wheel, or can include multiple LED light sources respectively emitting light of red, green and blue colors; and the display unit can include digital micro-mirror device (DMD) reflective minors. In another embodiment, the image output module 1024 is a 3LCD projector; the optical unit is a high pressure lamp or a color wheel; and the display unit can include three LCD panels. In another embodiment, the image output module 1024 is an RGB-LED device; the optical unit can include multiple LED light sources respectively emitting light of red, green and blue colors; and the display unit can be an LCD panel. As to the self-emission devices, the optical unit of the OLED or PDP device serves as the display unit. In embodiments of the invention, depending on the image output module 1024 employed, the color wavelength distributions of the left frame LF and the right frame RF from the digital signal processor 1022 vary in different image output module 1024. Accordingly, the color wavelength distributions could be adjusted in various ways depending on which type of the image output module 1024 is adopted.

In on embodiment, the digital signal processor 1022 isolates the left frame LF and/or the right frame RF from the 3D image signals 3DSIG. Furthermore, when the image output module 1024 outputs the left frame LF and/or the right frame RF, the digital signal processor 1022 provides color wavelength distributions corresponding thereto. The color wavelength distributions are described in detail as the following.

The left frame LF and the right frame RF generated from the digital signal processor 1022 have respective, different color wavelength distributions. These color wavelength distributions can be in various arrangements, such as three colors (LF) to three colors (RF) (also called 3*3 color matrix), two colors to three colors (also called 2*3 color matrix), two colors to two colors (also called 2*2 color matrix), or one color to three colors (also called 1*3 color matrix). In other words, in one embodiment of 3*3 color matrix, the color wavelength distribution of the left frame LF corresponds to three colors, and the color wavelength distribution of the right frame RF corresponds to three colors too. In another embodiment of 2*3 color matrix, the color wavelength distribution of the left frame LF corresponds to two colors, and the color wavelength distribution of the right frame RF corresponds to three colors. In yet another embodiment of 2*2 color matrix, the color wavelength distribution of the left frame LF corresponds to two colors, and the color wavelength distribution of the right frame RF corresponds to two colors. In still another embodiment of 1*3 color matrix, the color wavelength distribution of the left frame LF corresponds to one color, and the color wavelength distribution of the right frame RF corresponds to three colors. Generally, the colors mentioned are red, green and blue. It should be appreciated that selection of the color wavelength distribution is determined at the system design stage. The invention is not limited to these above-mentioned arrangements for the color wavelength distributions. Preferably, the digital signal processor 1022 provides a color matrix (not shown) that may be 3*3, 2*3, 2*2, or 1*3 color matrix. After the 3D image signals 3DSIG are converted into the signals for the left frame LF and the right frame RF, the image output module 1024 generates respective color wavelength distributions according to a color matrix (not shown) therein. The respective color wavelength distributions correspond to the left frame LF and the right frame RF.

Preferably, the color wavelength distributions of the left frame LF and the right frame RF employ a 3*3 color matrix, i.e. three colors (red (R1), green (G1) and blue (B1)) to three colors (red (R2), green (G2) and blue (B2)). Here, red (R1) and red (R2) may have slightly different wavelength distributions but both still belong to the range of 620-750 nm. In other words, wavelength distributions of red (R1) and red (R2) do not overlap completely. For example, red (R1) has the wavelength distribution of 620-700 nm, and red (R2) has the wavelength distribution of 670-750 nm. Preferably, the difference between wavelength distributions is negligible to the user. Also in the similar way, green (G1) and green (G2) may have slightly different wavelength distributions but both still belong to the range of 495-570 nm; blue (B1) and blue (B2) may have slightly different wavelength distributions but both still belong to the range of 450-495 nm. Note that the colors could be also orange (590-620 nm), yellow (570-590 nm), violet (380-450 nm), or other primary colors. Moreover, the wavelength distribution for one color could be continuous or discontinuous.

In this embodiment, the left frame LF having the color wavelength distribution corresponding to red (R1), green (G1) and blue (B1) and the right frame RF having the color wavelength distribution corresponding to red (R2), green (G2) and blue (B2) are generated. Thereafter, the image output module 1024 outputs an output frame IMG according to the left frame LF and the right frame RF. The color wavelength distribution for the output frame IMG from the image output module 1024 is represented as its corresponding wavelength WL, as described later.

The image receiving unit 104 receives the output frame IMG including the left frame LF and the right frame RF, and respectively filters different wavelengths (or colors) WLL and WLR through the left receiving unit 1042 and the right receiving unit 1044. In one embodiment, the left receiving unit 1042 only allows the wavelength including red (R1), green (G1) and blue (B1) to pass, and the right receiving unit 1044 only allows the wavelength including red (R2), green (G2) and blue (B2) to pass. The left receiving unit 1042 and the right receiving unit 1044 respectively receive the left frame LF and the right frame RF of different wavelength distributions, leading to that the user perceives the image signals 3DSIG with full color (red, green and blue) through the image receiving unit 104.

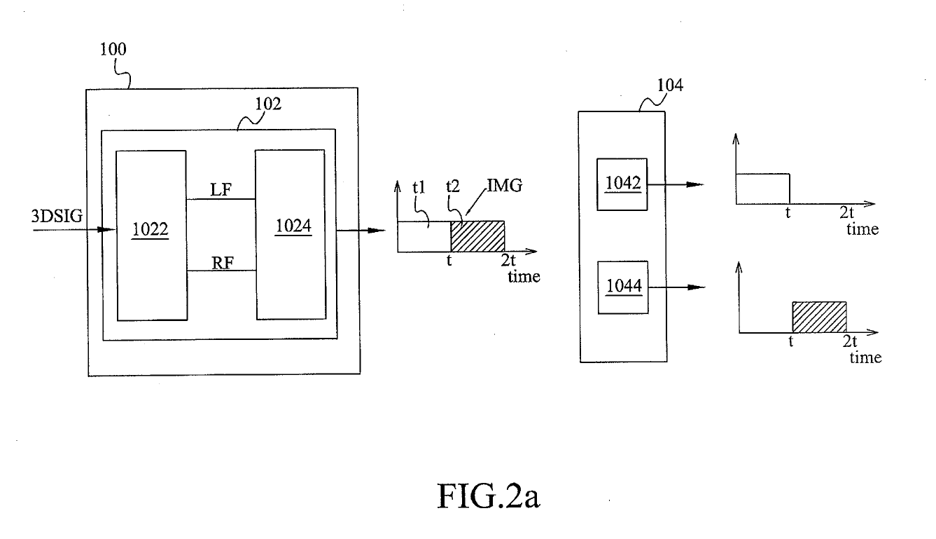

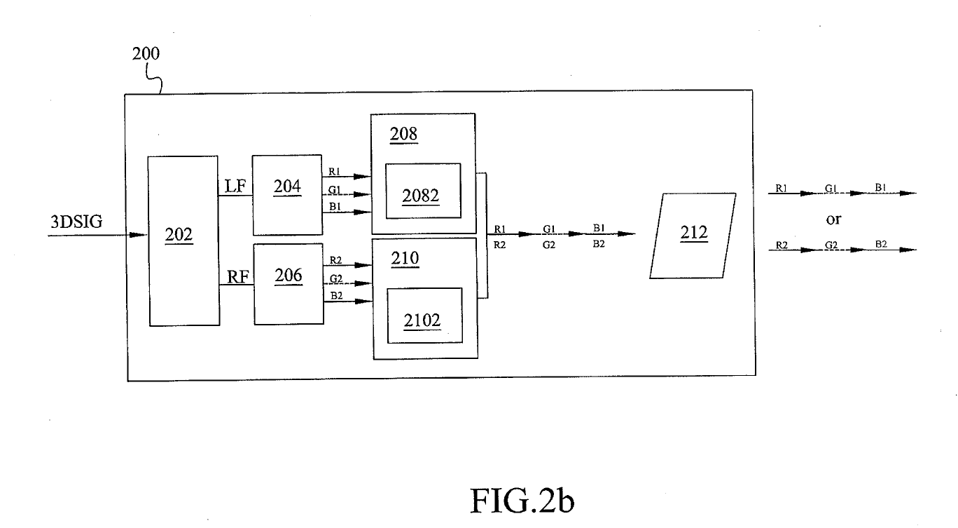

FIG. 2a depicts the display device or three-dimensional (3D) images shown in FIG. 1. In this embodiment, the 3D image signals 3DSIG are converted to a left frame LF (also called a first frame) and a right frame RF (also called a second frame) via a display unit 102. An output frame IMG including the left frame LF or the right frame RF is then output via the image output module 1024 of the display unit 102. That is, the image output module 1024 outputs the output frame IMG including the left frame LF during a first frame time “t1” (i.e., a period between 0 and t), and outputs the output frame IMG including the right frame RF during a second frame time “t2” (i.e., a period between t and 2t). It is noted that the left frame LF and the right frame RF described here are generated from the same 3D image signals 3DSIG. The left frame LF and the right frame RF, however, correspond to different color wavelength distributions. In one embodiment, the left frame LF has a first color wavelength distribution, and the right frame RF has a second color wavelength distribution. The first color wavelength distribution is different from the second color wavelength distribution. For example, the first color wavelength distribution corresponds to red (R1), green (G1) and blue (B1), and the second color wavelength distribution corresponds to red (R2), green (G2) and blue (B2). The difference, such as wavelength or intensity, between the first and second color wavelength distributions corresponding to red (R1) and red (R2) (or green (G1) and green (G2), or blue (B1) and blue (B2)) is as small as possible, so as to prevent loss of display quality.

During a first frame time “t1,” only the left frame LF is inputted into the image receiving unit 104 to reach both the left receiving unit 1042 and the right receiving unit 1044. However, only the left receiving unit 1042 allows the left frame LF having the first color wavelength distribution to pass while the right receiving unit 1044 blocks the left frame LF. During a second frame time “t2,” only the right frame RF is inputted into the image receiving unit 104, and only the right receiving unit 1044 allows the right frame RF having the second color wavelength distribution pass while the left receiving unit 1042 blocks the right frame RF. As a result, the user perceives the left frame LF having the first color wavelength distribution via the left receiving unit 1042 during the first frame time “t1,” and perceives the right frame RF having the second color wavelength distribution via the right receiving unit 1042 during the second frame time “t2”. Because the first frame time “t1” or the second frame time “t2” is shorter than a duration of persistence of vision for the user, the user can perceive the image signals 3DSIG with full color through the image receiving unit 104.

It is noted that the display device for three-dimensional (3D) images of this embodiment can be a projector with a backlight source or a PDP device. That is, the image output module 1024 outputs the left frame LF having the first color wavelength distribution during the first frame time “t1,” and outputs the right frame RF having the second color wavelength distribution during the second frame time “t2”. A 3D image projector, e.g., a digital light processing (DLP) projector, capable of subsequently outputting the left frame LF and the right frame RF is described as the following.

FIG. 2b is a scheme illustrating one embodiment of a DLP projector 200 in accordance with the present invention. In this embodiment, the DLP projector 200 includes a includes a digital signal processor 202, a first optical driving unit 204, a second optical driving unit 206, a first optical unit 208, a second optical unit 210, and a display unit 212. 3D image signals 3DSIG are isolated, via a digital signal processor 202, into signals for a left frame LF (also called a first frame) and a right frame RF (also called a second frame). The first optical driving unit 204 receives the signals of the left frame LF from the digital signal processor 202, and makes the first optical unit 208 emit light. The second optical driving unit 206 receives the signals of the right frame RF from the digital signal processor 202, and makes the second optical unit 210 emit light. The first optical unit 208, according to the signals of the left frame LF from the first optical driving unit 204, generates a first color wavelength distribution corresponding to red (R1), green (G1) and blue (B1). The first optical unit 208, for example, can be a high-pressure lamp or a color wheel. Alternatively, the first optical unit 208 can include multiple LED light sources respectively emitting light of red (R1), green (G1) and blue (B1). The second optical unit 210, according to the signals of the right frame RF from the second optical driving unit 206, generates a second color wavelength distribution corresponding to red (R2), green (G2) and blue (B2). The second optical unit 210, for example, can be a high-pressure lamp or a color wheel. Alternatively, the second optical unit 210 includes multiple LED light sources respectively emitting light of red (R2), green (G2) and blue (B2). Red (R1), green (G1), blue (B1), red (R2), green (G2) and blue (B2) represents different wavelengths. A difference between the corresponding colors of the first and second color wavelength distributions is negligible to the user. That is, the user can still perceive the 3D images as long as the difference is within the so-called “accepted color difference tolerances for human”.

The first optical unit 208 includes a first light integration unit 2082, and the second optical unit 210 includes a second light integration unit 2102. The first light integration unit 2082 and the second light integration unit 2102 are an optical element, containing highly reflective materials, for guiding and focusing light. That is, incident light and diffusion light into an incoming side of the first light integration unit 2082 and the second light integration unit 2102 is continuously reflected therein and then transmitted to an outgoing side thereof. Accordingly, the left frame LF having the first color wavelength distribution corresponding to red (R1), green (G1) and blue (B1) and the right frame RF having the second color wavelength distribution corresponding to red (R2), green (G2) and blue (B2) are uniformly and subsequently transmitted to the display unit 212 via the first light integration unit 2082 and the second light integration unit 2102, respectively. The display unit 212 may include digital micro-mirror device (DMD) reflective mirrors. The display unit 212 receives signals from the first optical unit 208 and presents the left frame LF having the first color wavelength distribution corresponding to red (R1), green (G1) and blue (B1). The display unit 212 also receives signals from the second optical unit 210 and presents the right frame RF having the second color wavelength distribution corresponding to red (R2), green (G2) and blue (B2). It is noted that the DLP projector 200 of this embodiment has only one display unit, i.e., the first display unit 212, therefore the DLP projector 200 only output the left frame LF or the right frame RF during a frame time. As long as the frame time is shorter than a duration of persistence of vision for the user, the user still can perceive the image signals 3DSIG.

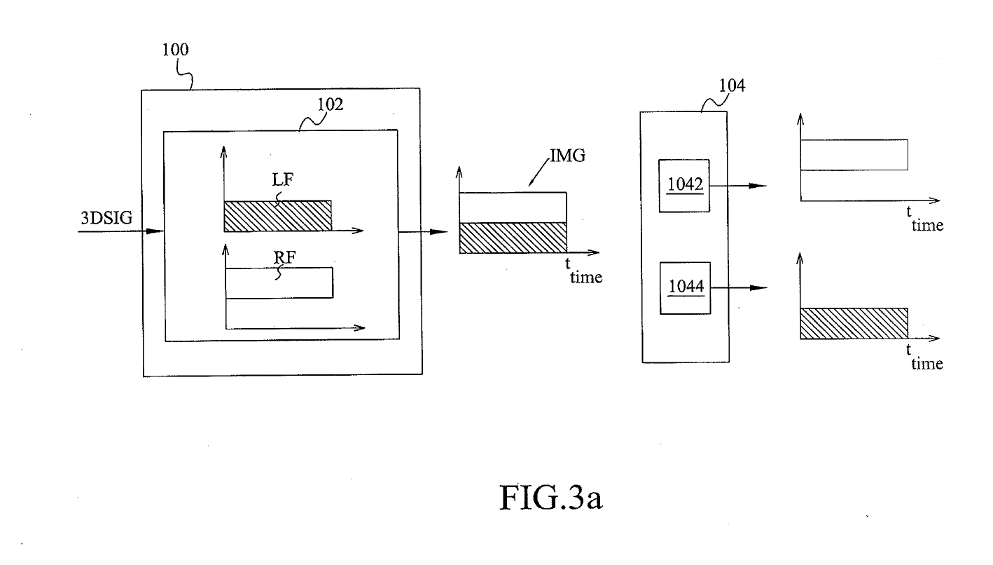

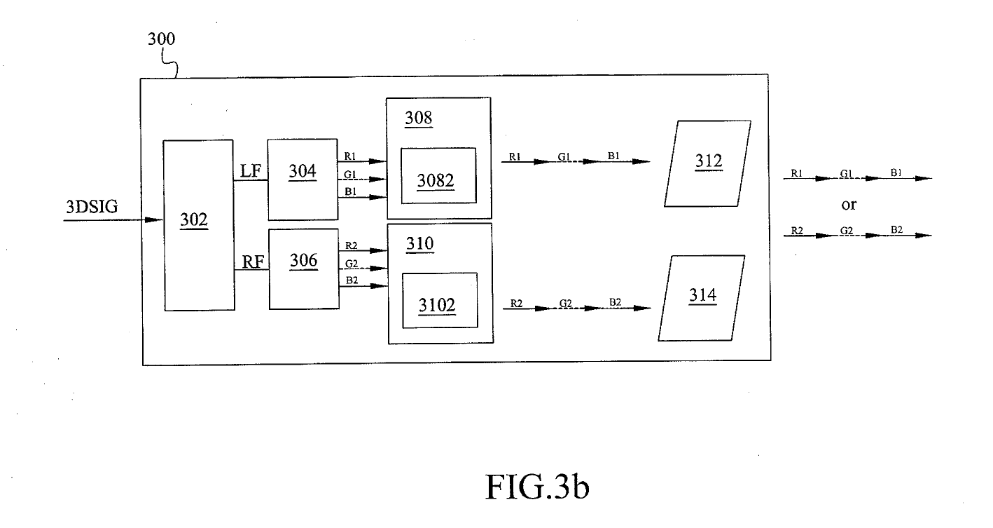

FIG. 3a depicts the display device shown in FIG. 1. In this embodiment, 3D image signals 3DSIG are converted to an output frame IMG including a left frame LF (also called a first frame) and a right frame RF (also called a second frame) superimposed thereon via a display unit 102. The output frame IMG output from the image output module of the display unit 102 corresponds to a frame time “t”. In this embodiment, the image output module 1024 simultaneously outputs the output frame IMG including the left frame LF and the right frame RF which are superimposed. It is noted that the left frame LF and the right frame RF described here are generated from the same 3D image signals 3DSIG. The left frame LF and the right frame RF, however, correspond to different color wavelength distributions. In one embodiment, the left frame LF has a first color wavelength distribution, and the right frame RF has a second color wavelength distribution. The first color wavelength distribution is different from the second color wavelength distribution. For example, the first color wavelength distribution corresponds to red (R1), green (G1) and blue (B1), and the second color wavelength distribution corresponds to red (R2), green (G2) and blue (B2). The difference, such as wavelength or intensity, between the first and second color wavelength distributions corresponding to red (R1) and red (R2) (or green (G1) and green (G2), or blue (B1) and blue (B2)) is as small as possible, so as to prevent loss of display quality.

Both the left receiving unit 1042 and the right receiving unit 1044 of the image receiving unit 104 receive the output frame IMG. That is, both the left receiving unit 1042 and the right receiving unit 1044, during a frame time, receive the left frame LF having the first color wavelength distribution and the right frame RF having the second color wavelength distribution. However, the left receiving unit 1042 only allows the left frame LF having the first color wavelength distribution pass, and the right receiving unit 1044 only allows the right frame RF having the second color wavelength distribution pass. As a result, the user can perceive the left frame LF having the first color wavelength distribution via the left receiving unit 1042, and perceive the right frame RF having the second color wavelength distribution via the right receiving unit 1044, therefore perceiving the 3D images with full color.

It is noted that the display device for three-dimensional (3D) images of this embodiment can be a DLP projector, a 3LCD projector or other image output modules capable of simultaneously outputting two frames. That is, the output frame IMG including the left frame LF and the right frame RF is simultaneously output during the first frame time “t”. A 3D image projector, e.g., a digital light processing (DLP) projector, capable of simultaneously outputting the left frame LF and the right frame RF is described as the following.

FIG. 3b illustrates a DLP projector 300 in accordance with one embodiment of the present invention. In this embodiment, the DLP projector 300 includes a digital signal processor 302, a first optical driving unit 304, a second optical driving unit 306, a first optical unit 308, a second optical unit 310, a first display unit 312, and a second display unit 314. 3D image signals 3DSIG are isolated, via a digital signal processor 302, into signals for a left frame LF (also called a first frame) and a right frame RF (also called a second frame). The first optical driving unit 304 receives the signals of the left frame LF from the digital signal processor 302, and makes the first optical unit 308 emit light. The second optical driving unit 306 receives the signals of the right frame RF from the digital signal processor 302, and makes the second optical unit 310 emit light. The first optical unit 308, according to the signals of the left frame LF from the first optical driving unit 304, generates a first color wavelength distribution corresponding to red (R1), green (G1) and blue (B1). The first optical unit 308, for example, can be a high pressure lamp or a color wheel. Alternatively, the first optical unit 308 may include multiple LED light sources respectively emitting light of red (R1), green (G1) and blue (B1). The second optical unit 310, according to the signals of the right frame RF from the second optical driving unit 306, generates a second color wavelength distribution corresponding to red (R2), green (G2) and blue (B2). The second optical unit 310, for example, can be a high pressure lamp or a color wheel. Alternatively, the second optical unit 310 may include multiple LED light sources respectively emitting light of red (R2), green (G2) and blue (B2).

The first optical unit 308 includes a first light integration unit 3082, and the second optical unit 310 includes a second light integration unit 3102. The first light integration unit 3082 and the second light integration unit 3102 are an optical element for guiding and focusing light. Accordingly, the left frame LF having the first color wavelength distribution corresponding to red (R1), green (G1) and blue (B1) is uniformly and simultaneously transmitted to the first display unit 312. The right frame RF having the second color wavelength distribution corresponding to red (R2), green (G2) and blue (B2) is uniformly and simultaneously transmitted to the second display unit 314. The first display unit 312 and the second display unit 314 may include digital micro-mirror device (DMD) reflective mirrors. The first display unit 312 receives signals from the first optical unit 308 and presents the left frame LF having the first color wavelength distribution corresponding to red (R1), green (G1) and blue (B1). The second display unit 314 receives signals from the second optical unit 310 and presents the right frame RF having the second color wavelength distribution corresponding to red (R2), green (G2) and blue (B2). It is different from the embodiment of FIG. 2 that the DLP projector 300 of this embodiment has the first display unit 312 and the second display unit 314, thus, the DLP projector 300 can simultaneously output the left frame LF and the right frame RF during a frame time.

In other embodiments, the first and second color wavelength distributions may be adjusted depending on needs. For example, at least one of the first color wavelength distribution and the second color wavelength distribution corresponds to at least two colors selected from a color group consisting of red, green, and blue. In another embodiment, both of them correspond to at least two colors selected from a color group consisting of red, green, and blue. In still another embodiment, at least one of the first color wavelength distribution and the second color wavelength distribution corresponds to three colors of red, green, and blue. In yet another embodiment, both of them correspond to three colors of red, green, and blue.

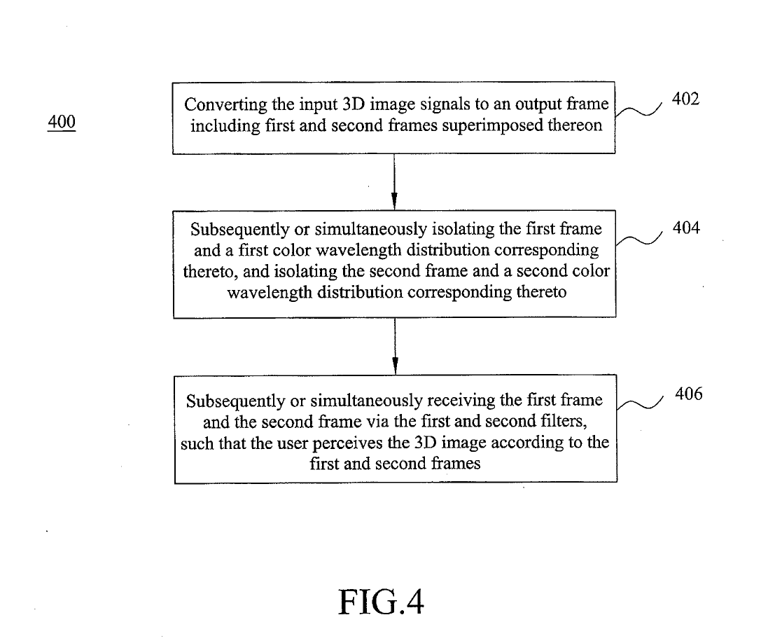

FIG. 4 is a flowchart illustrating one embodiment of a method 400 for generating three-dimensional (3D) images in accordance with the present invention. In step 402, the input 3D image signals are converted, by calculation of a color conversion matrix, to an output frame including first and second frames superimposed thereon. In step 404, the method proceeds to subsequently or simultaneously isolate the first frame and a first color wavelength distribution corresponding thereto, and to isolate the second frame and a second color wavelength distribution corresponding thereto. In step 406, the method precedes to subsequently or simultaneously receive the first frame and the second frame via the first and second filters, such that the user perceives the 3D image according to the first and second frames.

Although specific embodiments have been illustrated and described, it will be obvious to those skilled in the art that various modifications may be made without departing from what is intended to limited solely by the appended claims.

1. A display device for three-dimensional (3D) images, respectively presenting a first and second frames to left and right eyes of a user, whereby the user perceives a 3D image according to the first and second frames, the display device comprising:
a digital signal processor for generating the first and second frames according to 3D image signals; and
an image output module for outputting the first and second frames sequentially;
wherein the first frame has a first color wavelength distribution, and the second frame has a second color wavelength distribution;
wherein the first color wavelength distribution is different from the second color wavelength distribution, and at least one of the first color wavelength distribution and the second color wavelength distribution corresponds to at least two colors selected from a color group consisting of red, green, and blue.

2. The display device of claim 1, wherein both the first color wavelength distribution and the second color wavelength distribution correspond to colors of red, green, and blue.

3. The display device of claim 2, wherein a difference between the corresponding colors of the first and second color wavelength distributions is negligible to the user.

4. The display device of claim 1, wherein the second frame follows the first frame after a frame time, and the frame time is shorter than a duration of persistence of vision for the user.

5. The display device of claim 1, wherein the display device is a self light-emitting display device or a display device including a backlight.

6. The display device of claim 1, wherein the display device is a DLP projector including two optical units for generation of the first and second frames.

7. The display device of claim 6, wherein the two optical units are LED light sources respectively generating light of the first and second color wavelength distributions.

8. The display device of claim 6, further comprising a display unit including DMD reflective mirrors so as to receive signals from the two optical units and to present the first and second frames sequentially.

9. The display device of claim 6, further comprising two optical driving units, wherein the digital signal processor is connected to the optical driving units to control the optical unit.

10. A display device for three-dimensional (3D) images, presenting a frame to a first filter corresponding to the left eye of a user and to a second filter corresponding to the right eye of the user, the first filter allowing light of a first color wavelength distribution to pass and the second filter allowing light of a second color wavelength distribution to pass, the frame being filtered respectively by the first and second filters, the display device comprising:
a digital signal processor for generating the frame according to 3D image signals, the frame further including first and second frames superimposed thereon; and
an image output module for outputting the frame;
wherein the first frame has the first color wavelength distribution, and the second frame has the second color wavelength distribution;
wherein the first color wavelength distribution is different from the second color wavelength distribution, and at least one of the first color wavelength distribution and the second color wavelength distribution corresponds to at least two colors selected from a color group consisting of red, green, and blue, whereby the user perceives the 3D image according to the first and second frames.

11. The display device of claim 10, wherein both the first color wavelength distribution and the second color wavelength distribution correspond to colors of red, green, and blue.

12. The display device of claim 10, wherein a difference between the corresponding colors of the first and second color wavelength distributions is negligible to the user.

13. The display device of claim 10, wherein the display device is a self light-emitting display device or a display device including a backlight.

14. The display device of claim 10, wherein the display device is a DLP projector including two optical units for generation of the first and second frames.

15. The display device of claim 14, further comprising:
two display units, respectively receiving signals from the two optical units so as to respectively present the first and second frames.

16. The display device of claim 14, further comprising two optical driving units, wherein the digital signal processor is connected to the optical driving units to control the optical unit.

17. A method for generating three-dimensional (3D) images, a user utilizing first and second filter to perceive the 3D image, the method comprising:
generating an output frame according to 3D image signals, the output frame including first and second frames superimposed thereon;
isolating the first frame and a first color wavelength distribution corresponding thereto;
isolating the second frame and a second color wavelength distribution corresponding thereto; and
subsequently or simultaneously receiving the first frame and the second frame via the first and second filters, such that the user perceives the 3D image according to the first and second frames.

18. The method of claim 17, wherein a difference between the corresponding colors of the first and second color wavelength distributions is neglectable to the user.

19. The method of claim 17, wherein the second frame follows the first frame after a frame time, and the frame time is shorter than a duration of persistence of vision for the user.

20. The method of claim 17, wherein the first color wavelength distribution is different from the second color wavelength distribution, and at least one of the first color wavelength distribution and the second color wavelength distribution corresponds to at least two colors selected from a color group consisting of three primary colors.
